(19) United States
(12) Patent Application Publication
(10) Pub. No.: US 2018/0345875 A1
(43) Pub. Date: Dec. 6, 2018

(54) HOLDER FOR MOTOR VEHICLES FOR RECEIVING MOBILE DEVICES

(71) Applicant: Thomas BUCHHALTER, Niederkassel (DE)

(72) Inventor: Thomas BUCHHALTER, Niederkassel (DE)

(21) Appl. No.: 16/101,898

(22) Filed: Aug. 13, 2018

Related U.S. Application Data
(63) Continuation-in-part of application No. 13/989,862, filed on May 28, 2013, now abandoned.

(30) Foreign Application Priority Data
Nov. 25, 2010 (DE) 202010015867

(51) Int. Cl. B60R 11/02; F16M 11/04

(52) U.S. Cl. CPC B60R 11/0241; F16M 13/02; F16M 11/041

(57) ABSTRACT

A holder for motor vehicles for receiving a mobile device, which may have a housing and clamping jaws for clamping the mobile device. The housing may be equipped with a dedicated power supply for the clamping operation, such that the clamping jaws are movable electromechanically for opening or closing purposes.

### CROSS-REFERENCE TO RELATED APPLICATIONS

This application claims priority as a continuation-in-part from U.S. patent application Ser. No. 13/989,862, filed on May 28, 2013, entitled “HOLDER FOR MOBILE VEHICLES FOR RECEIVING MOBILE DEVICES,” which is a U.S. national stage application of, and claims priority under 35 U.S.C. § 371 to, International Patent Application No. PCT/EP2011/070916, filed on Nov. 24, 2011, which claims priority to German Patent Application No. 202010015867, filed on Nov. 25, 2010, the disclosures of which are incorporated by reference herein in their entireties.

### BACKGROUND

The invention refers to a holder for receiving mobile devices, in particular navigation or communication apparatuses, in vehicles.

Such a holder, i.e. a clamping device for mobile apparatuses, is known, for example, from DE 296 18 476.

A holder such as is provided above may include two clamping jaws supported in a housing, which are adapted to be pressed manually so as to retain a mobile apparatus in a certain locked position of the clamping jaws. The adjustable clamping jaws allow the holder to be adapted to different apparatuses so that such holders can be offered as universal devices for different mobile apparatuses.

The mobile apparatuses may be navigation or communication apparatuses for instance, such as mobile phones or smart phones.

The mobile apparatuses are mechanically clamped or locked in the holder. Others are biased against a spring and are then unlocked again.

In quite a few cases, the operation requires the use of both hands.

This is inconvenient and partly difficult and practicable only with both hands.

Furthermore, certain electromechanical holders for mobile apparatuses may be known, which may be equipped with a separate power supply, and which may have clamping jaws adapted to be moved electromechanically for closing and opening.

### SUMMARY

The present application provides a holder of the electromechanical type mentioned above which offers a further improvement to the ease of use and offers additional functionalities to the user.

An exemplary embodiment may advantageously provide that the housing may be additionally equipped with a wireless charging device, with the wireless charging device connected to the energy supply and adapted for generating and transmitting an electromagnetic radiation for charging of the mobile apparatus. An exemplary embodiment may overcome the disadvantages described above by providing wireless charging functionality by transmitting electromagnetic radiation to the wireless apparatus fixed to the holder.

It is preferably provided that the holder additionally may include an electric motor, which is provided to move at least one of the clamping jaws.

The energy supply may be effected from the on-board supply of the vehicle via a connector cable and/or from an integrated battery/accumulator unit or it may additionally be provided with solar cells, i.e. such that an integrated battery/accumulator unit can also be assisted by solar cells.

Preferably, the housing may be provided with a first sensor, which is arranged at the housing to detect the insertion of the mobile apparatus, and a second sensor to detect an object, as well as an electronic unit.

The electronic unit can be configured to activate and/or deactivate the wireless charging device in response to a signal supplied to the electronic unit by the first and/or second sensor.

Preferably the electronic unit is configured that the electronic unit causes the clamping jaws to open or close in response to a signal supplied by the first and/or second sensor fed to the electronic unit. As an example, it can be foreseen, that the first sensor is adapted to sense the introduction of the mobile apparatus into the holder and that the electronic unit causes the clamping jaws to close and/or deactivates the wireless charging device if a mobile apparatus is detected.

Additionally, the second proximity sensor can be configured to sense an approaching object or detect a swiping movement/gesture above the sensor. For example, in the case when a mobile apparatus is introduced into and clamped in the holder a user can perform a swipe gesture whereupon the electronic unit deactivates the wireless charging device and/or causes the clamping jaws to be opened.

In an alternative embodiment the holder can be equipped with a single proximity sensor, which is adapted to sense a swiping gesture performed above the sensor and is further configured to sense a direction of the performed gesture. Thereby the user can, for example, during the process of introducing and attaching the mobile apparatus to the holder, cause the holder to close the clamping jaws and activate the wireless charging device by performing a dedicated swiping action above the sensor in a first direction. For releasing the mobile apparatus from the holder the users can perform the dedicated swiping gesture in the opposite direction with respect to the first swiping direction above the sensor.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 depicts an exemplary embodiment of a housing of the holder.

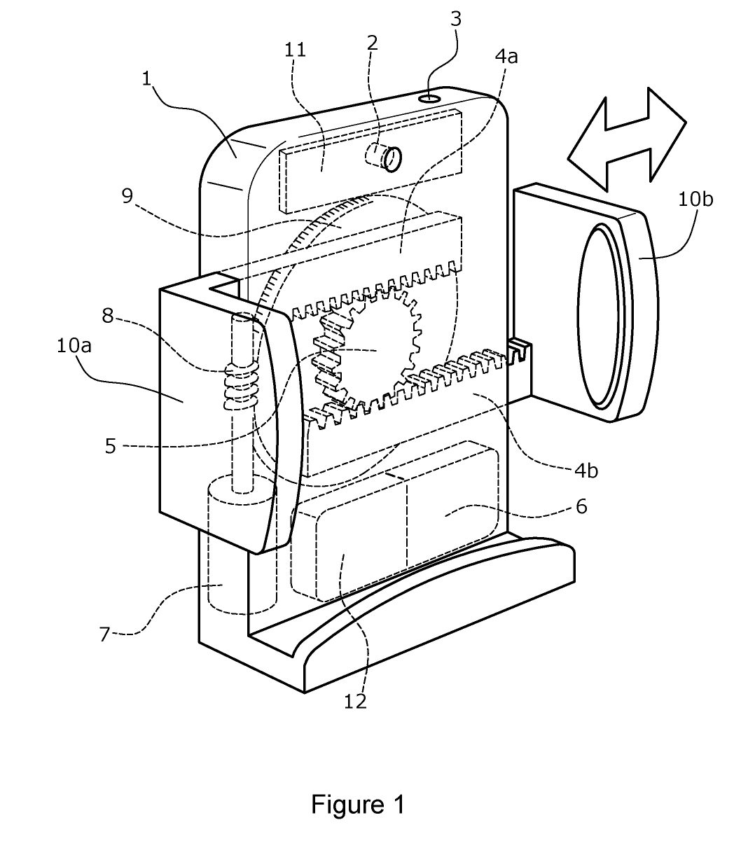

### DETAILED DESCRIPTION

The following is a detailed description of an embodiment of the invention with reference to the sole FIGURE.

The sole FIGURE illustrates a housing 1 of the holder in which two clamping jaws 10a, 10b are supported for movement in the direction of an arrow. At the lower end of the housing 1, a support surface for a mobile apparatus is provided on which the mobile apparatus can be supported from below. When the mobile device is placed on this surface and rests on a rear support surface of the housing 1, a first sensor 2 arranged in the housing 1 detects the presence of the mobile apparatus, e.g. through an opening in the housing 1, whereupon an electronic unit 11 arranged in the housing 1 controls a drive motor 7 to drive the clamping jaws 10a, 10b and/or controls the wireless charging device 12. Preferably, the motor 7 is coupled with the clamping jaws 10a, 10b via a transmission unit, wherein, in the embodiment illustrated, the transmission unit includes a drive screw 8 driven by the motor 7, the drive screw meshing with a large drive pinion 9 via the toothing. The large pinion 9 is coaxially coupled with a small pinion 5 for rotation therewith. The small pinion 5 meshes with two toothed drive bars 4a, 4b movable in the direction of the arrow and preferably guided linearly, the bars being fixedly connected with a respective clamping jaw 10a and 10b. When the small pinion 5 rotates clockwise, with respect to the drawing, the clamping jaws 10a, 10b perform a closing movement, whereas, upon a rotational movement in the counterclockwise direction, the clamping jaws 10a, 10b are opened. For opening, the motor 7 is rotated in the opposite sense. The control receives a corresponding command via the second sensor 3 arranged at the housing. The first and second sensors 2,3 may be configured as optical, capacitive or mechanical sensors, e.g. in form of a button or of a touch-sensitive sensor. Current-saving sensors are preferred. Brightness-sensors, for example a photodiode or ultrasonic-sensors can be used as touchless sensors for the first and second sensor 2,3.

The wireless charging device 12 can be integrated in the housing 1 and is configured to transmit electromagnetic radiation when activated; the radiation can be transmitted for example by an electronic coil arrangement. The transmitted radiation can be received by specifically adapted coils which are included in the mobile apparatuses as for example mobile phones and the radiation can be transformed into energy in the mobile apparatus, which can be used for charging the apparatus. The electromagnetic radiation can be as an example a continuously changing magnetic field, which is generated by an alternating current supplied to a coil arrangement. For example wireless charging mats and corresponding receivers are known in the art, such as devices which operate according to the so called QI standard. The wireless charging device 12 is connected to the power supply 6 as well as to the electronic unit 11 for the control of the activation/deactivation of the wireless charging device 12.

It is understood that other drive and transmission units can also be used to move the clamping jaws.

The electronic unit 11 can store a clamping position for a particular mobile apparatus, wherein, in this case, the opening position of the clamping jaws 10a, 10b is obtained by the clamping jaws 10a, 10b moving part by a short predetermined distance. In this manner, short opening and closing paths are achieved, so that the power consumption during the operation of the holder is low.

A battery or accumulator unit may be integrated in the housing, the accumulator advantageously being adapted to be charged also via a solar cell when light impinges thereon.

Storing the clamping position can be performed in a simple manner by the electronic unit 11 itself by detecting the clamping state, e.g. the rise in the power consumption of the motor 7.

When another mobile apparatus, e.g. a wider mobile apparatus, is to be held in the holder, it is sufficient, for example, to operate the opening sensor 3 twice or for a longer time in order to move the clamping jaws 10a, 10b to the fully open position. Again, the maximum opening position can be detected by the electronic unit 11 when the drive bars 4a, 4b connected with the clamping jaws 10a, 10b abut against a stop. The clamping position for the new mobile apparatus can then be stored as described above.

It is intended, in particular, to avoid the necessity of an inconvenient two-handed operation.

The holder is designed as a passive holding head that can be applied to various supporting systems of various manufacturers which are known for fastening in the interior of a vehicle, preferably on the dashboard or the windshield, e.g. using a suction cup having a pivot arm.

Advantageously, the electromechanically actuable holder is designed such that it is pivotable and can thus be pivoted from a vertical orientation of the mobile apparatus to a horizontal orientation. Further, it is intended to provide an integrated possibility for charging the mobile apparatus.

Preferably, the power for the clamping operation is provided by a battery/accumulator unit 6 integrated in the holder, which unit may also be supported by a solar cell that further reduces the energy consumption of the battery when it is light or that charges the accumulator unit during the day.

The electromechanical holder is intended for accommodation in a housing which is preferably made of plastic material.

Clamping is effected by two clamping jaws 10a, 10b that are moved electromechanically for opening or closing.

The drive may advantageously be electric.

The motor 7 drives a transmission unit formed by the elements 4a, 4b, 5, 8 and 9 which open and close the clamping jaws 10a, 10b.

The control of the unit 11 can be designed such that the mobile apparatus is pressed against a first sensor 2 arranged at the housing 1, whereby the clamping operation is started. Alternatively the first sensor 2 is a touchless sensor, as for example an ultrasonic sensor. The touchless sensor 2 is configures in such a way to detect the introduction or approaching mobile apparatus in the area of the holder, in the case that a mobile apparatus is introduced to the mobile holder the first touchless sensor 2 generated a signal, which is fed to the electronic unit 11. In response to the signal of the first touchless sensor 2, the electronic unit 11 causes the clamping jaws 10a,10b to close and/or to activate the wireless charging device 12.

The clamping and/or activation of the wireless charging device is then advantageously deactivated by means of an second sensor 3 preferably arranged at the top of the housing, the second sensor 3 sensing an approaching object or a hand of the user above the sensor 3. In the case that the second sensor 3 detects an approaching object, a signal is fed by the sensor 3 to the electronic unit 11, which the causes the clamping jaws 10a,10b to open and/or deactivated the wireless charging device 12. The second sensor 3 can be an ultrasonic distance sensor or a brightness sensor, for example a photodiode.

An adjustment to different widths of mobile terminal apparatuses is done automatically by storing a position in an electronic unit 11 upon the first movement.

The deactivation of and the correct contact pressure for the clamping is detected and stored by the integrated electronic unit 11.

When the opening sensor 3 is actuated, the clamping is released slightly so that the mobile apparatus can be removed easily.

Due to the slight opening, only a small closing distance needs to be traveled when the mobile terminal apparatus reinserted to be used again, which again is favorable in terms of energy consumption.

The foregoing description and accompanying FIGURES illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

1. A holder for use in motor vehicles for receiving a mobile device, with a housing, with clamping jaws for clamping the mobile device, and equipped with a dedicated power supply, wherein the clamping jaws are movable electromechanically by the energy supplied by the power supply for opening or closing purposes,
wherein the housing is additionally equipped with a wireless charging device, wherein the charging device is connected to the power supply and adapted to transmit electromagnetic radiation for charging the mobile device received by the holder.

2. The holder of claim 1, wherein an electric motor is provided for moving at least one of the clamping jaws.

3. The holder of claim 1, wherein the power supply is provided with solar cells.

4. The holder of claim 1, wherein the housing is equipped with a first sensor for detecting the presence of a mobile device, a second sensor for detecting an approaching object and an electronic unit.

5. The holder of claim 4, wherein the electronic unit is configured to activate and deactivate the charging device in dependence on sensor signals from at least one of the first sensor or second sensor.

6. The holder of claim 5, wherein the electronic unit controls the opening and closing of the clamping jaws in dependence on sensor signals supplied from at least one of the first sensor or the second sensor (2,3).

7. The holder of claim 5, wherein the electronic unit stores opening and closing positions of the clamping jaws.

8. The holder of claim 5, wherein the second sensor is adapted to sense a swiping gesture above the second sensor.
